(19) United States
(12) Patent Application Publication
(10) Pub. No.: US 2009/0017837 A1
(43) Pub. Date: Jan. 15, 2009

(54) System and method for determining position of mobile communication device

(76) Inventors: Tae Kim, II, Seoul (KR); Sung Kang, II, Seoul (KR); Tae Kyoung Kwon, Seoul (KR); Sung Hee Kim, Seoul (KR); Won Seok Lee, Seoul (KR)

Correspondence Address: NIXON & VANDERHYE, PC, 901 NORTH GLEBE ROAD, 11TH FLOOR, ARLINGTON, VA, 22203, US

(21) Appl. No.: 10/576,817

(22) PCT Filed: Sep. 9, 2005
(86) PCT No.: PCT/KR2005/002978

§ 371 Date: Apr. 24, 2006

(30) Foreign Application Priority Data
Sep. 17, 2004 (KR) 10-2004-0074421
Nov. 23, 2004 (KR) 10-2004-0096104

(51) Int. Cl. H04Q 7/20

(52) U.S. Cl. 455/456.1

(57) ABSTRACT

Provided is a method and system for determining a position of a mobile communication device in a mobile communication network, the method including the steps of: receiving a plurality of pieces of base station signal information, the base station signal information including base station identification information, the base stations transmitting the base station signal information to the mobile communication device; determining a base station corresponding to each of the plurality of pieces of base station signal information based on the base station identification information; generating vector information associated with the plurality of the base stations based on geographic information corresponding to the determined base station; and generating location information of the device according to the generated vector information, wherein the step of generating the vector information comprises the steps of: determining a predetermined vector proceeding order associated with the plurality of the base stations according to the base station signal information; and sequentially determining a vector with respect to the plurality of the base stations according to the determined vector proceeding order, with the base station in which the device is currently communicating with as a starting point.

### TECHNICAL FIELD

The present invention relates to a method and system for determining a position of a mobile communication device in a mobile communication network, and more particularly, to a method and system for determining a position of a mobile communication device, in which a first determination by generating a plurality of vectors based on base station signal information received from a base station and geographic information of a repeater is compared with a second determination based on grids dividing a mobile communication network to finally determine a position of a mobile communication device.

### BACKGROUND ART

Nowadays, since notable development of mobile communication rapidly accelerates popularization of mobile communication devices, now many people usually carry a mobile communication device such as a mobile phone and PDA. Mobile communication devices enable users to easily access a communication network and enable system resources of a conventional system to be effectively distributed.

A location based service (LBS) is one type of mobile communication services using a position of a mobile communication device. The location based service (LBS) indicates a service that simply and quickly provides various pieces of information associated with a position of a user while the user moves via wireless communication. The LBS is used in checking and tracking a position in response to an accident or a disaster in the case an emergency occurs, quickly providing traffic information or surrounding region information, or providing various pieces of information associated with leisure such as a tourist showplace. In addition, the LBS is used in various fields such as mobile commerce based on position such as shopping for local specialties or memorials and impromptu ticketing or the administration of physical distribution (tracking a freight and vehicles).

There is a method using pseudo-random noise (PN) phase delay, a method depending on a cell radius, and a method of determining a position for each specifically divided unit in conventional methods of determining a position based on a mobile communication network.

In determining a position of a mobile communication device, in a position determination method based on a conventional mobile communication network, a relative time difference is converted into ‘a distance’ by using the PN phase delay, and a time difference of arrival (TDOA), an advanced forward link triangulation (AFLT), an enhanced observed time difference (E-OTD), and an observed time difference of arrival (OTDOA), which are methods of substituting for triangulation, are used. However, the position determination methods have a problem due to base station signal information reflected or dispersed being received via an indirect path in addition to direct base station signal information received from a base station or a repeater. The problem due to the indirect path is more serious than noise, and a solution for the problem is urgently needed. Also, in the base station signal information received from the base station, since a timepiece of the repeater is not precise or the property of the system of the repeater is different from each other repeater, there is a great possibility of generating a problem of variability of PN phase delay of the repeater. It may act as an important variable in determining a position of a mobile communication device whether base station signal information received by the mobile communication device is received from the base station or the repeater.

There is Cell ID method and Enhanced Cell ID (EX, CITA+RXLEV) method, which depend on the radius of a cell. Since the methods largely depend on the radius of a cell, there is a great error in position information of a mobile communication device in an area whose cell radius is large, such as the outskirts of town and a screened area. Also, since the PN strength of base station signal information received from each base station is variable, there is a problem of not sufficiently satisfying the accuracy that is initially required.

### DISCLOSURE OF INVENTION

### Technical Goals

To solve the problems of conventional technologies, the present invention provides a method of determining a position of a mobile communication device, in which a vector based on base station signal information received from a base station is generated to determine position information of the mobile communication device, thereby using existing base station signal information as is.

The present invention also provides a method of determining a more precise position of a mobile communication device by determining whether base station signal information is received from a repeater.

The present invention also provides a method of providing more precise and reliable position information of a mobile communication device with reference to position information according to a conventional position determination method.

The present invention also provides a method of continuously providing precise position information by reflecting a change of a communication network due to installation and change of a base station or repeater.

### Technical Solutions

According to an aspect of the present invention, there is provided a method of determining a location of a mobile communication device in a mobile communication network including a plurality of base stations, including the steps of: receiving a plurality of pieces of base station signal information, the base station signal information including base station identification information, the base stations transmitting the base station signal information to the mobile communication device; determining a base station corresponding to each of the plurality of pieces of base station signal information based on the base station identification information; generating vector information associated with the plurality of the base stations based on geographic information corresponding to the determined base station; and generating location information of the device according to the generated vector information, wherein the step of generating the vector information includes the steps of: determining a predetermined vector proceeding order associated with the plurality of the base stations according to the base station signal information; and sequentially determining a vector with respect to the plurality of the base stations according to the determined vector proceeding order, with the base station in which the device is currently communicating with as a starting point.

### BRIEF DESCRIPTION OF DRAWINGS

FIG. 1 is a diagram illustrating an example of a configuration of a network including a position determination system according to the present invention and a conventional mobile communication network;

FIG. 2 is a flowchart illustrating a position determination method according to a preferable embodiment of the present invention;

FIG. 3 is a diagram illustrating the configuration of a database including geographic information corresponding to a predetermined base station in the present invention;

FIGS. 4 through 6 are diagrams illustrating a method of determining a position of a mobile communication device by using a vector in a mobile communication network based on a synchronous network;

FIGS. 7 through 9 are diagrams illustrating a method of determining a position of a mobile communication device by using vector information generation according to the present invention in a mobile communication network based on an asynchronous network;

FIG. 10 is a flowchart illustrating a process of a position determination method based on a self-learning methodology according to the present invention;

FIG. 11 is a diagram illustrating an area covered by a mobile communication network, which is divided into a plurality of grids, and second position information in each of the grids;

FIG. 12 is a diagram illustrating an example of a second database;

FIG. 13 is a flowchart illustrating a process performed in each step of a weight average method according to the present invention;

FIG. 14 is a block diagram illustrating the internal configuration of a position determination system according to a preferable embodiment of the present invention; and

FIG. 15 is a block diagram illustrating the internal configuration of a general use computer apparatus that may be employed in performing the method of determining a position of a mobile communication device, according to the present invention.

### BEST MODE FOR CARRYING OUT THE INVENTION

Hereinafter, a system and method of determining a position of a mobile communication device, according to the present invention, will be described in detail with reference to the attached drawings.

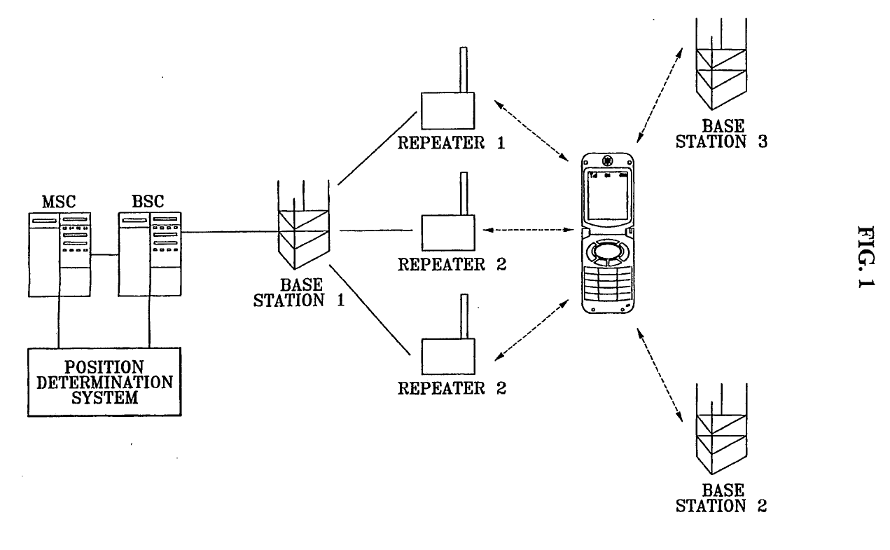

FIG. 1 is a diagram illustrating an example of the configuration of a network including a position determination system according to the present invention and a conventional mobile communication network.

As illustrated in FIG. 1, the mobile communication network includes a plurality of base stations and a mobile communication device of a user receives each piece of base station signal information from the plurality of the base stations. The plurality of the base stations includes a reference base station in which the mobile communication device is currently communicating with, and peripheral base stations. The mobile communication device may continually receive a plurality of pieces of base station signal information from not only base stations in a cell in which the mobile communication device is located, but also base stations in peripheral cells. The mobile communication device transmits the received base station signal information to the position determination system according to the present invention, and the position determination system determines a position of the mobile communication device according to a vector method based on a database including geographic information with respect to each base station. Also, in the present invention, the meaning of “the base station signal information is received from the mobile communication device” is understood as not only a case in which the position determination system directly receives the base station signal information but also a case in which the base station signal information received from the mobile communication device is stored in a certain system (or space) of a communication network and the position determination system accesses the certain system to obtain the base station signal information.

Also, the position determination system stores second position information obtained by an existing method of determining a position of a mobile communication device in a second database and generates final position information by referring to the second position information, thereby generating more precise and reliable position information of the mobile communication device.

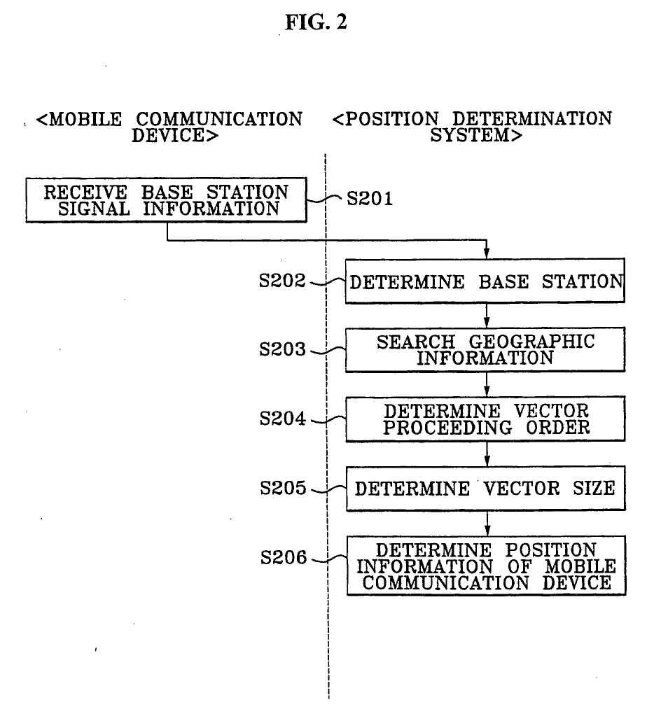

FIG. 2 is a flow chart illustrating a position determination method according to a preferable embodiment of the present invention. Hereinafter, processes performed by respective steps will be described in detail with reference to FIG. 2.

A mobile communication device receives base station signal information from a plurality of base stations. A mobile communication network according to the present invention may be based on a synchronous network or an asynchronous network. If a mobile communication network is based on a synchronous network, each base station signal may include PN offset, PN phase delay, and received signal strength. The PN offset includes information for identifying what base station the received base station signal is transmitted from. The PN phase delay is a propagation delay time till a base station signal is received by a mobile communication device. The received signal strength indicates the strength of a base station signal received by a mobile communication device. In step S201, a mobile communication device receives base station signal information. Therefore, the position determination system according to the present invention may use the base station signal information received by the mobile communication device.

On the other hand, if a mobile communication network is based on an asynchronous network, each base station signal may include base station identification information (or cell identification information), received signal strength, and round trip time. Their purposes are corresponding to the purposes of the information included in the base station signal of the described synchronous network.

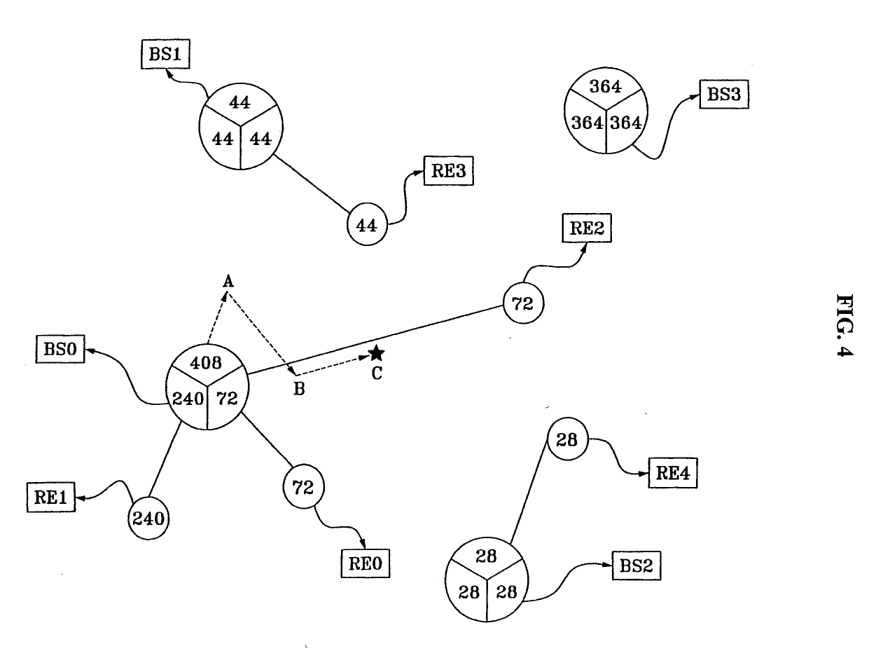

Next, in step S202, a base station corresponding to each of the base station signal information is determined based on the received base station signal information. For example, the relevant base station may be identified and determined based on a PN offset of the base station signal information. Step S202 with respect to base station determination will be described in detail with reference to FIGS. 4 through 9.

In step S203, geographic information of the base station is searched and retrieved from a database. For example, geographic information of a base station may be stored and maintained in a database and be obtained by searching the database.

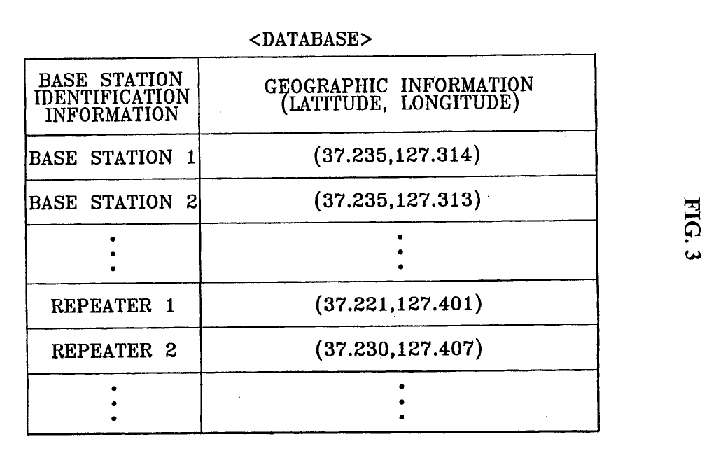

FIG. 3 is a diagram illustrating the configuration of a database including geographic information corresponding to a predetermined base station, in the present invention.

As illustrated in FIG. 3, the database according to an example of the present invention includes base station identification information identifying a base station and geographic information of the relevant base station. In this case, latitude and longitude may be used as an example of the geographic information. For example, geographic information corresponding to base station 1 is a latitude of 37.235 and a longitude of 127.314.

From step S204 of FIG. 2, vector information for performing the method of determining a position of a mobile communication device, according to the present invention, is generated based on the geographic information detected in step S203.

For this, in step S204, a vector proceeding order associated with the plurality of the base stations is determined according to the base station signal information. For example, a base station whose propagation delay time is shorter may be determined to be the priority when considering propagation delay time included in the base station signal. On the other hand, the ranking of the base station may be determined in the order of greatest to lowest received signal strength when considering the received signal strength. The vector with respect to the plurality of the base stations may be sequentially determined according to the vector proceeding order previously determined as a virtual path from a first base station to a second base station. According to a preferable embodiment of the present invention, an initial start point of the vector may be based on a reference base station in which the mobile communication device is currently communicating with.

In step S205, the size of the vector whose proceeding order is determined in step S204 is determined. For example, the size of the vector may be determined by multiplying the length of the vector connecting a previous base station with a subsequent base station by a predetermined value. The length of the vector is a distance between the first base station and the second base station and may be computed by using geographic information (latitude, longitude) of the first base station and the second base station. As an example of the present invention, an empirical value with respect to the predetermined value may determined to be 0.20. Accordingly, a first vector is determined by multiplying the length of the vector from the first base station to the second base station by 0.20.

Next, a second vector is determined by starting with a terminal point of the first vector as a new start point. Namely, by starting with the terminal point of the first vector, a new virtual path toward a third base station of a new subsequent order is determined. A direction of the vector from the new starting point to the third base station is determined and a length between the starting point and the third base station is computed and multiplied by a second predetermined value, thereby determining the vector. As an example for the present invention, an empirical value with respect to the predetermined value for determining the size of the second vector, according to the present invention, may be determined to be 0.15.

Next, starting with a terminal point of the second vector, a virtual transfer path toward a new subsequent fourth base station is determined. A direction from the starting point to the subsequent fourth base station is determined, a third vector is determined by computing a distance between the starting point and the fourth base station, and an empirical value 0.1 with respect to a predetermined value for determining the size of the third vector is multiplied by the computed distance of the vector.

In step S206, position information of the mobile communication device is obtained based on the vector proceeding order and vector size determination. In the method of determining a position, according to the present invention, a terminal point of the third vector is a position of the mobile communication device. Namely, the terminal point of the vector may correspond to the position information of the mobile communication device. As an additional embodiment, as illustrated in FIG. 1, a mobile communication network may include a plurality of repeaters in addition to base stations. The repeater amplifies a weak electric wave of a base station signal received from the base station by a mobile communication device. The repeater is generally used as equipment that improves communication quality in a screened area to which a base station signal can not be directly received, and a building and underground where the electric wave environment is not good, and improves the coverage of a system. Particularly, since cost for installation, maintenance, and repairs is low and a site for installation is easily acquired, the repeater is commonly used as equipment that can minimize investment cost of mobile communication provider.

However, in the case a mobile communication network includes repeaters, a base station signal received by a mobile communication device may be a signal directly received from a base station or a signal transmitted via at least one repeater. If a base station signal is transmitted via repeater, the vector for determining a position of a mobile communication device, according to the present invention, may be determined based on a repeater instead of a base station. Therefore, it has to be first determined whether the base station signal is received via repeater or directly received from a base station.

For example, the base station signal may be distinguished by using propagation delay time information included in the base station signal. Namely, in the case of a synchronous network, the base station signal is distinguished based on PN phase delay, and, in the case of an asynchronous network, the base station signal is distinguished based on a round trip time. In the case of an asynchronous network, TA (timing advance) may be used in a second generation network (2G network) and RTT (round trip time) may be used in a third generation network (3G network), as a round trip time.

Hereinafter, the method of determining a position of a mobile communication device, previously described in FIG. 2, will be describe in detail.

FIGS. 4 through 6 are diagrams illustrating a method of determining a position of a mobile communication device by using a vector in a mobile communication network based on a synchronous network.

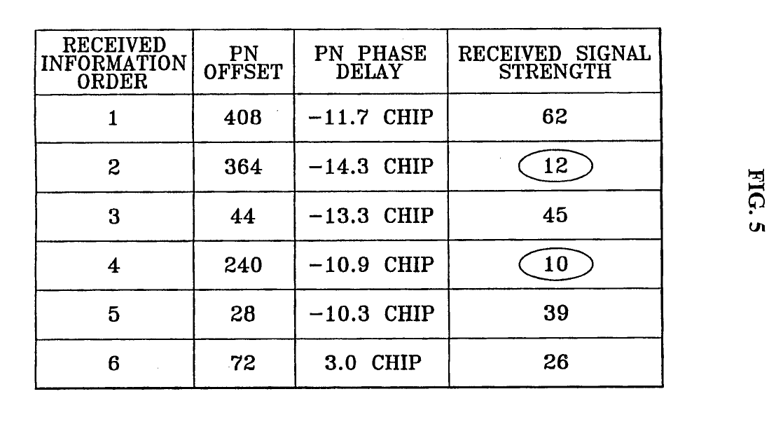

As illustrated in FIG. 4, a mobile communication device receives each base station signal information from a reference base station BS0 and peripheral base stations BS1, BS2, and BS3. Each received base station signal information is transmitted to the position determination system according to the present invention. The position determination system arranges a plurality of pieces of the base station signal information based on propagation delay time information. As illustrated in FIG. 5, after a base station signal of the reference base station whose PN offset is 408, an order may be determined in order of small propagation delay time, based on PN phase delay.

Next, it has to be determined whether base station signal information received by a mobile communication device is received via repeater or directly received from a base station. Referring to FIG. 4, it is assumed that base stations whose signal information is received by the mobile communication device are BS0, BS1, BS2, and BS3, repeaters connected to the base station BS0 are RE0, RE1, and RE2, a repeater connected to the base station BS1 is RE3, and a repeater connected to the base station BS2 is RE4.

In this case, it is determined based on a propagation delay time (PN phase delay) difference between a base station signal being analyzed and an earliest received base station signal whose propagation delay time is smallest if a base station signal is transmitted via repeater. If the absolute value of the propagation delay time difference is more than a predetermined value (an empirical value: 6 to 8 chips), the base station signal being analyzed is determined to be received via repeater. If the absolute value of the propagation delay time difference is less than the predetermined value, the base station signal being analyzed is determined to be directly received from a base station.

For example, a base station signal whose received information order is 6 may be determined to be sent from the base station BS0 by considering the PN offset and determined to be received from a repeater because the propagation delay time difference is computed as −14.3 chip (PN offset: 364)−3.0 chip (PN offset: 72)=−17.3 chip.

Next, in the case base station signal information is determined to be transmitted via a repeater, it is required to determine which repeater is used among a plurality of repeaters connected to the base station. This is possible by choosing a repeater connected to a base station located closest to a base station corresponding to a signal that is earliest received. For example, referring to FIG. 4, the repeater RE2 located closest to the base station BS3 corresponding to the signal earliest received may be determined to be a repeater via which the signal being analyzed is transmitted.

Base stations corresponding to each base station signal may be determined or a repeater via which the signal is transmitted may be determined by applying the described methods to all of the base station signals of FIG. 5.

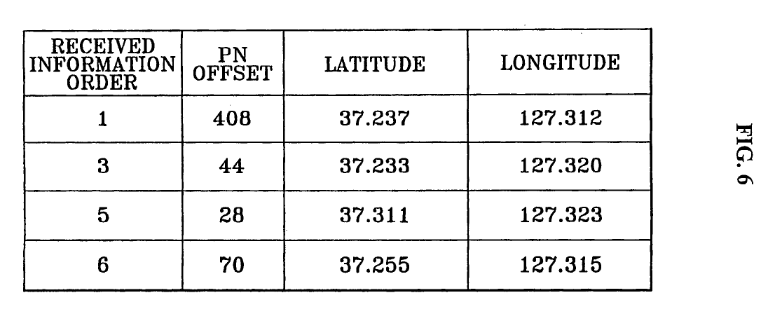

If relevant base stations or relevant repeaters corresponding to each base station signal is determined, vector information may be sequentially determined based on geographic information of the determined base stations or repeaters. However, vector information is not generated with respect to some base stations or repeaters of the plurality of pieces of base station signal information by considering received signal strength. For example, a base station signal having received signal strength having less than a certain value may be excluded, and the certain value may be empirically determined by considering the environments (geographical or natural features) of a relevant area. As a preferable embodiment of the present invention, in the case the certain value is determined to be 15, a final base station signal information list as shown in FIG. 6 requiring vector information generation may be obtained.

Referring to FIG. 6, vector information generation of FIG. 4 will be described. In FIG. 4, a starting point of a first vector is the reference base station BS0 and a terminal point of the first vector is the base station BS1 corresponding to a received information order 3 of FIG. 6, whose base station signal information is earliest received. Accordingly, a distance between the reference base station BS0 and the terminal point BS1 is computed by using geographic information (latitude, longitude) and multiplied by a predetermined empirical value 0.20 to determine the size of the first vector.

The terminal point A of the first vector is determined to be a starting point of a second vector, and the base station BS2 corresponding to a received information order 5 of FIG. 6 is determined to be a terminal point of the second vector to determine a direction of the second vector. The length of the second vector is multiplied by a predetermined empirical value 0.15 to determine the size of the second vector.

The terminal point B of the second vector is determined to be a starting point of a third vector and the repeater RE2 corresponding to a received information order 6 of FIG. 6 is determined to be a terminal point of the third vector to determine a direction of the third vector. The third vector is multiplied by a predetermined empirical value 0.10 to determine the size of the third vector.

By the described method, the first through third vector are sequentially determined, thereby generating position information of a mobile communication device based on a point (or a point multiplied by a predetermined value) corresponding to the terminal point of the third vector. As described above, a predetermined value determining the size of each vector may be gradually decreased as “0.2−>0.15−>0.10 according to the vector proceeding order.

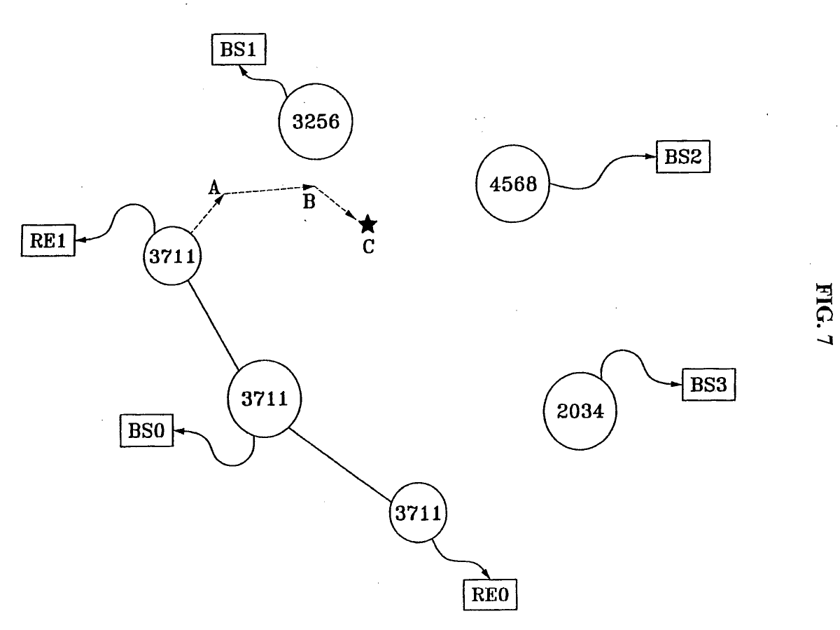

FIGS. 7 through 9 are diagrams illustrating a method of determining a position of a mobile communication device by using vector information generation according to the present invention, in a mobile communication network based on an asynchronous network.

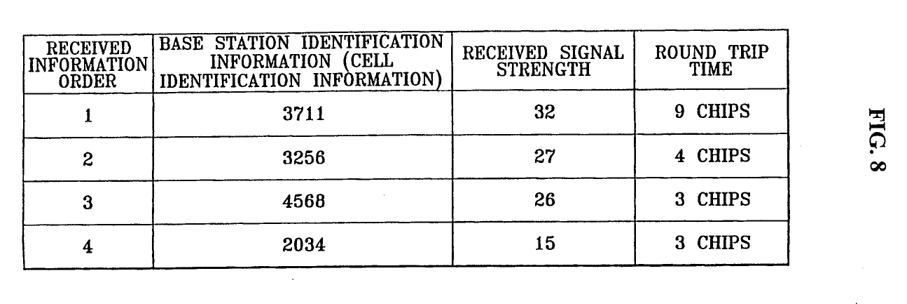

As illustrated in FIG. 7 as FIG. 4, a mobile communication device receives base station signal information from a reference base station BS0 and peripheral base stations BS1, BS2, and BS3. Received base station signal information is transmitted to a position determination system according to the present invention. The position determination system arranges a plurality of pieces of base station signal information based on received signal strength. Namely, as illustrated in FIG. 8, after a base station signal of a reference base station whose cell ID is 3711, the order of base station signal information may be in order of highest received signal strength. As another embodiment, the order of the base station signal information may be determined based on TA.

Next, it has to be determined whether base station signal information received by the mobile communication device is received via a repeater or directly received from a base station. Referring to FIG. 7, it is assumed that each base station whose signal is received by the mobile communication device is BS0, BS1, BS2, and BS3 and repeaters connected to the base station BS0 are RE0 and RE1.

In this case, if the round trip time of the reference base station BS0 received by the mobile communication device is more than a certain value (an empirical value: 5 to 7 chips), a signal received from the reference base station is determined to be received via a repeater, and if the round trip time is less than the certain value, a signal is determined to be directly received from a base station. Accordingly, in the case according to an example of the present invention as shown in FIG. 7, since a round trip time of a base station signal of received information order 1 is 9 chips, the signal may be determined to be received via a repeater connected to the reference base station BS0.

Next, in the case a signal is determined to be transmitted via a repeater, it is required to determine via which repeater among a plurality of repeaters connected to the base station the signal is received. The determination is possible by determining a position of a repeater connected to a base station located closest to a base station whose received signal strength is strongest subsequent to the reference base station. Namely, according to FIG. 7, a base station signal of a received information order 1 is determined to be transmitted via the repeater RE1 connected to the mother base station BS0 located closest to the base station BS1 whose received signal strength is strongest.

By applying the described methods to all of the base station signals shown in FIG. 8, a base station corresponding to each base station signal may be determined or a repeater via which the signal is transmitted may be identified.

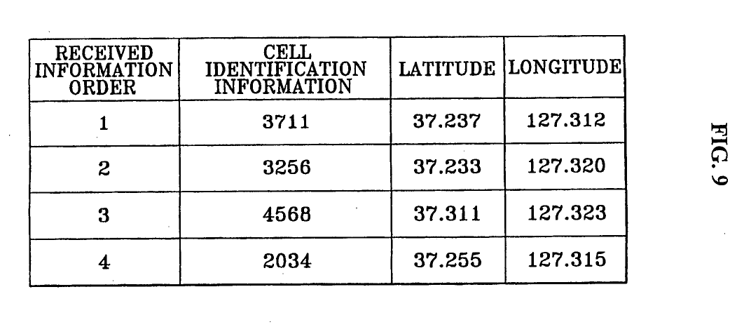

If a relevant base station or repeater corresponding to each base station signal is determined, vector information may be determined based on geographic information on the determined base station or repeater. However, in an asynchronous network, as in the synchronous network, the vector information may not be generated with respect to some base stations or repeaters by considering received signal strength. A base station or repeater whose received signal strength is less than a certain value may be excluded. As a preferable embodiment of the present invention, the certain value may be determined to be 10. As a result, finally, a final base station signal information list as shown in FIG. 9 requiring vector information generation may be obtained.

Referring to FIG. 9, vector information generation of FIG. 7 will be described. In FIG. 7, a starting point of a first vector is the repeater RE1, not the reference base station BS0, and a terminal point is the base station BS1 corresponding to a received information order 2 of FIG. 9, whose base station signal is earliest received. Accordingly, a vector direction from the reference base station BS0 to the base station BS1 is determined, a distance between the reference base station BS0 to the terminal point BS1 is computed by using geographic information (latitude, longitude), and the size of a first vector is determined to be a length obtained by multiplying the distance by a predetermined empirical value of 0.20.

The terminal point A of the first vector is determined to be a starting point of a second vector and a base station BS2 corresponding to a received information order 3 of FIG. 9 is determined to be a terminal point of the second vector to determine a direction of the second vector. The size of the second vector is determined by multiplying a length of the second vector by a predetermined empirical value 0.15.

The terminal point B of the second vector is determined to be a starting point of a third vector and a base station BS3 corresponding to a received information order 4 of FIG. 9 is determined to be a terminal point of the third vector to determine a direction of the third vector. The size of the third vector is determined by multiplying a length of the third vector by a predetermined empirical value 0.10.

By this method, the first vector through third vector are sequentially determined, thereby generating position information of a mobile communication device based on a point corresponding to the terminal point (or a point obtained by multiplying a predetermined value) of the third vector. As described above, a predetermined value determining the size of each vector, according to experience, may be gradually decreased as 0.2−>0.15−>0.10, according to a vector proceeding order.

Though the position information of the mobile communication device is determined from the terminal point of the third vector in FIGS. 7 through 9, it is clearly understood to those skilled in the art that the position information can be determined by applying the steps to the order of a fourth vector, a fifth vector, and so on, according to the number of the base station signal information received by the mobile communication device.

Up to this point, the method of detecting a position of a mobile communication device by generating vector information based on base station signal information is described. Hereinafter, in the case position information value different from the described vector method can be obtained by a conventional position determination method, a self learning methodology (SLM) in which the position determination system of the present invention can ultimately detect more precise position information by using conventional position determination method will be described.

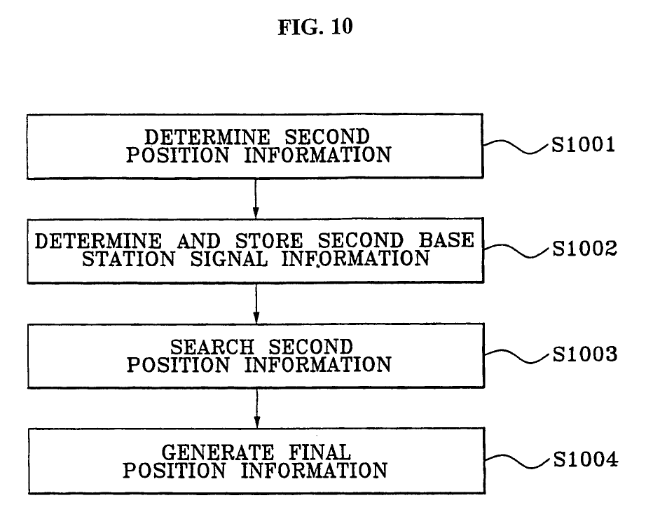

FIG. 10 is a flow chart illustrating a process of a position determination method based on a self learning methodology according to the present invention. Processes performed for each step will be described in detail with reference to FIGS. 10 through 12.

In step S1001, second position information is determined. An area covered by a mobile communication network is divided into a plurality of grids, and the second position information is corresponding to a grid. The second position information indicates information determined by a predetermined second mobile communication device position determination method, not by the vector method of the present invention, previously described in the description of FIG. 2. As the second mobile communication device position determination method, various conventional methods which can provide relatively precise position information value may be used. For example, there is a position determination method using a GPS receiving apparatus.

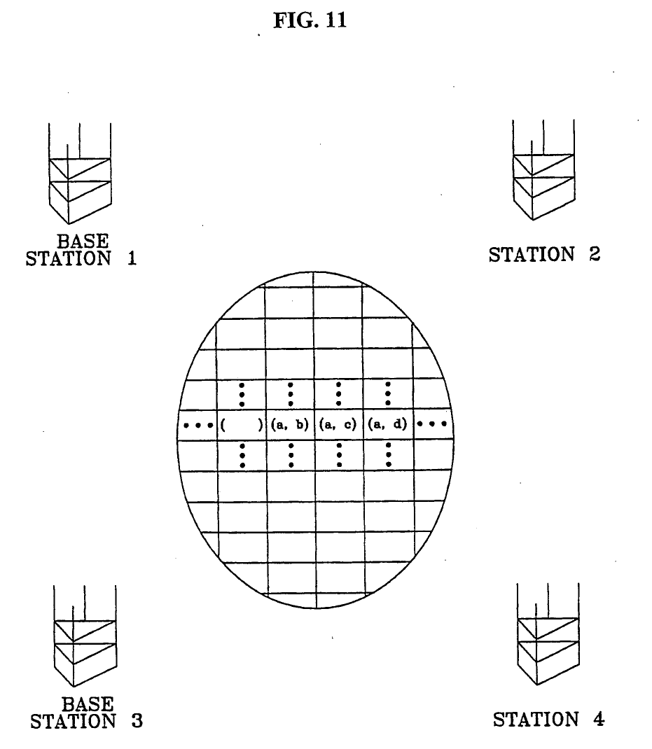

FIG. 11 is a diagram illustrating an area covered by a mobile communication network, which is divided into a plurality of grids, and second position information in each of the grids. The grid is a unit dividing two-dimensional geographic information (latitude, longitude) by a reference length. In this case, the reference length may be several tens of meters or several hundreds of meters. The second position information is a representative value or a certain value in the grid, which may be determined for each grid.

In step S1002, the second base station signal information for each grid is determined in association with second position information determined by the second position determination method and stored and maintained in a second database.

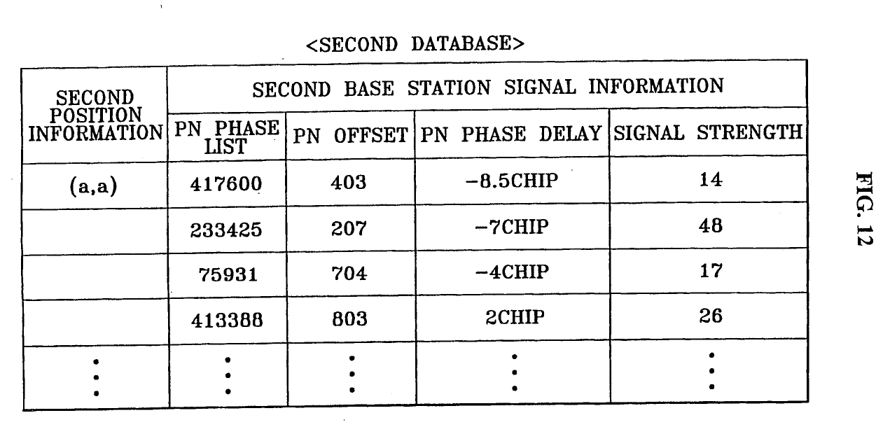

FIG. 12 is a diagram illustrating an example of a second database. As illustrated in FIG. 12, at least one second base station signal information may be stored for each second position information. As the second base station signal information, base station signal information for a few base station or repeaters, whose received signal strength is strongest, for example, may be selected and stored. On the other hand, only propagation delay time or received signal strength may be recorded. In FIG. 12, second base station signal information received from four base stations is stored with respect to a grid having second position information (a, a).

In step S1003, base station signal information used in the previous vector method is compared with the second base station signal information to search second position information corresponding to the base station signal information from the second database. Namely, according to the present invention, a position of a grid having information most similar to the base station signal information received by the mobile communication device is retrieved from the second database by using a pattern matching method, thereby obtaining second position information.

In step S1004, final position information is generated based on the retrieved second position information and the position information of the vector method. For example, an average of position information and second position information may be obtained to be determined to be final position information, or each information is multiplied by a predetermined weight and a result value may be determined to be final position information.

As an example according to the present invention, steps S1001 and S1002 may not be directly performed by the position determination system according to the present invention, and in the case a second database storing second base station signal information is already constructed, the position determination system searches and refers to the second database, thereby performing only the steps after step S1003.

As described above, according to the present invention, in determining a position of a mobile communication device, a first determination of the vector method described referring to FIG. 2 is combined with second determination of the grid based method described referring to FIGS. 10 through 12, thereby providing a more precise mobile communication device position determination method.

However, the grid based method can not quickly adapt to changes of mobile communication network. For example, in the case a base station or repeater is newly installed in a mobile communication network or the direction of reflection of an electric wave or configuration of a base station is changed, base station signal information corresponding to peripheral grids is changed. In order to update the change of the mobile communication network for itself and continuously provide precise position information, the position determination system according to the present invention may gradually reflect changes of signal information in the grid by using a weight average method.

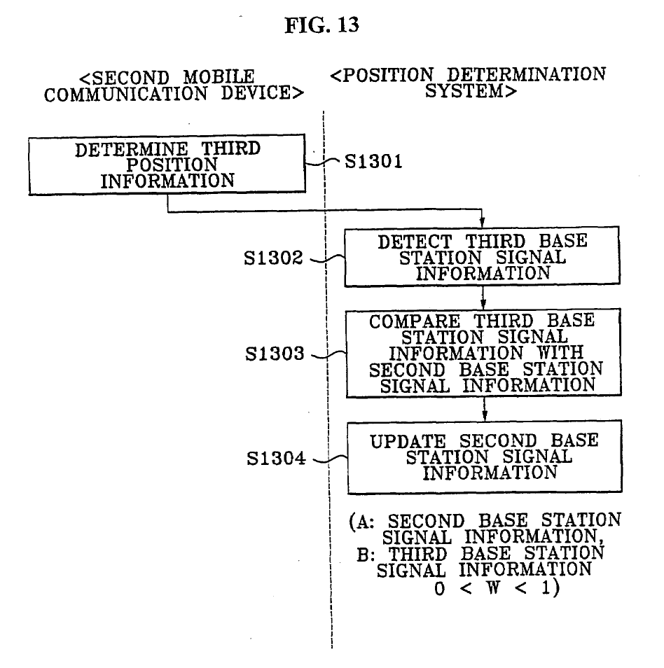

FIG. 13 is a flow chart illustrating a process performed in each step of a weight average method according to the present invention.

In step S1301, third position information is determined by using a second mobile communication device. Namely, third position information is obtained by using a second mobile communication device including a GPS receiving apparatus as another mobile communication device in addition to the previously used mobile communication device of the vector method.

Next, in step S1302, signal information that the second mobile communication device reports with respect to a base station in association with third position information, namely, third base station signal information is received.

In steps S1303 and S1304, the second base station signal information stored in the second database is updated in association with second position information corresponding to the third position information based on the third base station signal information. In this case, the second base signal information a′ updated and newly stored may be computed as Equation 1 by applying a predetermined weight to the conventional second base station signal information a and the newly reported third base station signal information b.

a′=w* a+(1−w)*b(0<w<1) Equation 1

a′: second base station signal information updated and stored

w: weight

a: second base station signal information

b: third base station signal information

As described above, according to the present invention, base station signal information varied with a change of the mobile communication network and is continuously updated in a database, thereby improving the precision of mobile communication device position determination method by using a grid based self learning methodology.

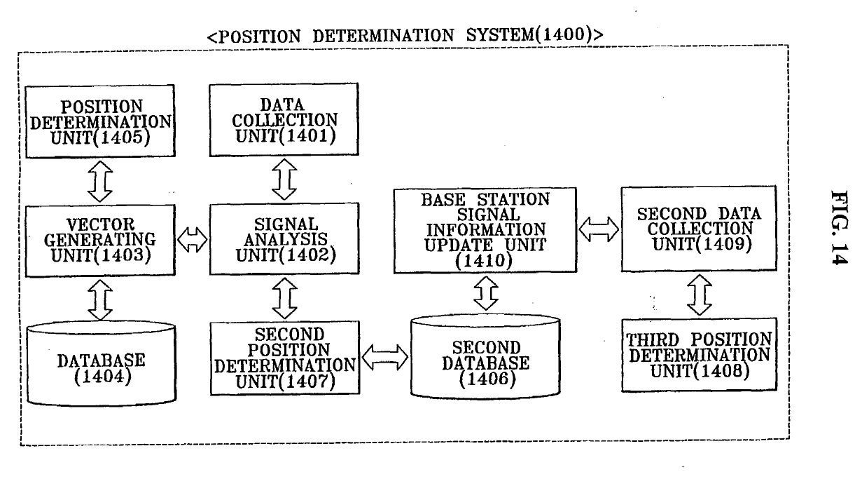

FIG. 14 is a block diagram illustrating the internal configuration of the position determination system according to a preferable embodiment of the present invention.

Referring to FIG. 14, a position determination system 1400 according to a preferable embodiment of the present invention includes a data collection unit 1401, a signal analysis unit 1402, a vector generating unit 1403, a database 1404, and a position determination unit 1405.

The data collection unit 1401 receives a plurality of pieces of base station signal information from a mobile communication device. The base station signal information includes propagation delay time information and indicates information received from a base station by the mobile communication device.

The signal analysis unit 1402 determines a base station or a repeater corresponding to each base station signal information based on the propagation delay time. Also, by comparing a propagation delay time difference between base station signals it may be determined whether a base station signal is transmitted via a repeater.

The vector generating unit 1403 generates vector information based on geographic information corresponding to the determined base station or repeater. To generate the vector information, a predetermined vector order associated with a plurality of base stations according to the base station signal information, starting with a base station or repeater in which the mobile communication device is currently communicating with, and a vector with respect to the plurality of the base stations is to be sequentially determined according to the determined vector proceeding order.

As an example, according to the present invention, a position determination system may further include a database 1404. The database 1404 stores geographic information on a plurality of base stations and repeaters. The vector generating unit 1403 may obtain the geographic information on the base stations or repeaters from the database 1404.

The position determination unit 1405 determines position information of the mobile communication device by using the vector information generated by the vector generating unit 1403.

The position determination system 1400 according to the present invention may further include a second database 1406 and a second position determination system 1407.

In the second database 1406, an area covered by a mobile communication network is divided into a plurality of grids and second base station signal information with respect to the divided grid is stored in association with second position information. The second position information may be determined by a predetermined second mobile communication device position determination method.

The second position determination unit 1407 compares the base station signal information with the second base station signal information to search second position information corresponding to the base station signal information from the second database and generates final position information based on the retrieved second position information and the position information.

As another embodiment, the position determination system 1400 according to the present invention may further include a third position determination unit 1408, a second data collection unit 1409, and a base station signal information update unit 1410.

The third position determination unit 1408 determines third position information by using a second mobile communication device including a GPS receiving apparatus. The second data collection unit 1409 receives third base station signal information with respect to the third position information by using the second mobile communication device.

The base station information update unit 1410 updates the second base station signal information stored in the second database 1406 with the second position information corresponding to the third position information based on the third base station signal information.

Since the configuration of the position determination system according to the present invention is described and technical contents previously described in the position determination method may be applied as is to the configuration of the system, a more detailed description will be omitted. The position determination system according to the present invention may be in the form of a position determination server (PDE) installed in a base station, a base station controller, or a base station relay, and the installation is not limited as long as a base station signal can be received. For example, the position determination system according to the present invention may be used independently connected to an existing core network (or a server system of a communication network) by considering management and investment efficiency.

As another embodiment according to the present invention, by considering resource environments of a mobile communication device, such as a processor, memory, and RF module, are rapidly improving, the configuration of the position determination system shown in FIG. 14 is mounted in a mobile communication device to be operated in the mobile communication device such that the mobile communication device can directly determine a position of the mobile communication device by using base station signal information received from each base station without the PDE via a mobile communication network. Namely, instead of installing a position determination system in a mobile communication network as an additional platform, the position determination system is installed in a mobile communication device. Therefore, in determining a position of a mobile communication device according to the embodiment described with reference to FIGS. 2 and 14, a load on the system, which can be generated due to a message mutually transmitted and received between the mobile communication device and a PDE, may be reduced and the cost for constructing an additional platform may be reduced such that a mobile communication provider may introduce and activate location based service (LBS) in a short time.

On the other hand, in installing the configuration of the position determination system of FIG. 14 in a mobile communication device, by considering restrictions on resources of the mobile communication device, only part of the configuration may be preferentially installed in the mobile communication device and the remaining part of the configuration may be additionally installed in a mobile communication network in the form of a platform. For example, the data collection unit 1401, the signal analysis unit 1402, the vector generating unit 1403, the database 1404, and the position determination unit 1405 may be installed in a mobile communication device in the form of a module, and other elements may be disposed in a mobile communication network.

The method of determining a position of a mobile communication device, according to the present invention includes a computer readable medium including a program instruction for executing various operations realized by a computer. The computer readable medium may include a program instruction, a data file, and a data structure, separately or cooperatively. The program instructions and the media may be those specially designed and constructed for the purposes of the present invention, or they may be of the kind well known and available to those skilled in the art of computer software arts. Examples of the computer readable media include magnetic media (e.g., hard disks, floppy disks, and magnetic tapes), optical media (e.g., CD-ROMs or DVD), magneto-optical media (e.g., floptical disks), and hardware devices (e.g., ROMs, RAMs, or flash memories, etc.) that are specially configured to store and perform program instructions. The media may also be transmission media such as optical or metallic lines, wave guides, etc. including a carrier wave transmitting signals specifying the program instructions, data structures, etc. Examples of the program instructions include both machine code, such as produced by a compiler, and files containing high-level languages codes that may be executed by the computer using an interpreter.

The hardware elements above may be configured to act as one or more software modules for implementing the operations of this invention.

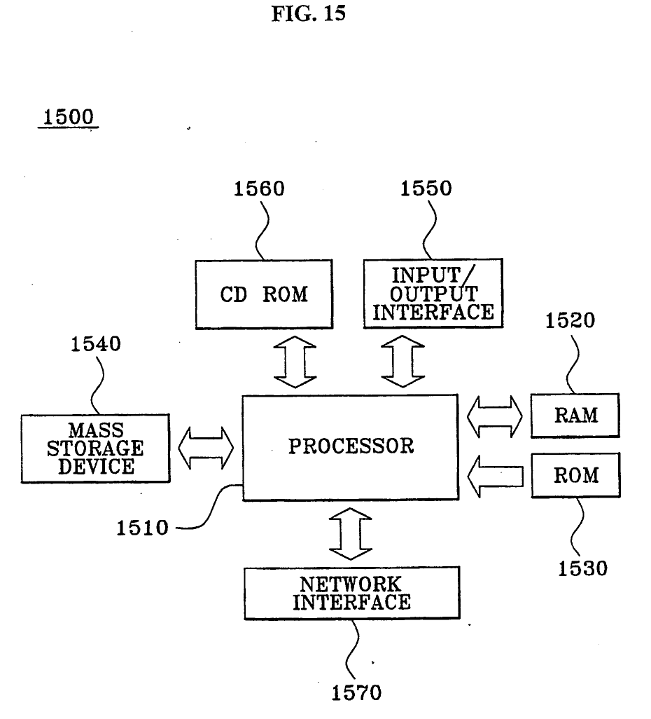

FIG. 15 is a block diagram illustrating the internal configuration of a general use computer apparatus that may be employed in performing the method of determining a position of a mobile communication device, according to the present invention.

A computer apparatus 1500 includes at least one processor 1510 connected to a main memory device including a RAM (Random Access Memory) 1520 and a ROM (Read Only Memory) 1530. The processor 1510 is also called as a central processing unit CPU. As well-known to the field of the art, the ROM 1530 unidirectionally transmits data and instructions to the CPU, and the RAM 1520 is generally used for bidirectionally transmitting data and instructions. The RAM 1520 and the ROM 1530 may include a certain proper form of a computer readable recording medium. A mass storage device 1540 is bidirectionally connected to the processor 1510 to provide additional data storage capacity and may be one of the computer readable recording medium. The mass storage device 1540 is used for storing programs and data and is an auxiliary memory. A particular mass storage device such as a CD ROM 1560 may be used. The processor 1510 is connected to at least one input/output interface 1550 such as a video monitor, a track ball, a mouse, a keyboard, a microphone, a touch-screen type display, a card reader, a magnetic or paper tape reader, a voice or hand-writing recognizer, a joy stick, and other known computer input/output unit. The processor 1510 may be connected to a wired or wireless communication network via a network interface 1570. The procedure of the described method can be performed via the network connection. The described devices and tools are well-known to those skilled in the art of computer hardware and software.

The described hardware devices may be formed to be operated by at least one software module in order to perform the operations of the present invention.

While this invention has been particularly shown and described with reference to preferred embodiments thereof, various changes in form and details may be made therein without departing from the spirit and scope of the invention as defined by the appended claims.

Therefore, the scope of the invention is defined not by the detailed description of the invention but by the appended claims, and all differences within the scope will be construed as being included in the present invention.

### INDUSTRIAL APPLICABILITY

According to the present invention, since a mobile communication device determines a position of a mobile communication device based on base station signal information received from a base station, a position of a mobile communication device may be determined without installing additional hardware based equipment in a mobile communication device in which a GPS receiving apparatus is not installed, or a mobile communication network.

The position determination method according to the present invention may be applied to a mobile communication network based on not only a synchronous network but also an asynchronous network and may be embodied in a mobile communication network including repeaters.

According to the present invention, more precise final position information may be determined by comparing position information according to a conventional position determination method with the vector method of the present invention.

According to the present invention, precise position information may be continuously provided by reflecting changes of mobile communication network, which are generated due to additional installation of a base station or a repeater.

According to the present invention, the position determination system is installed in a mobile communication device, thereby reducing the cost of constructing an additional platform and reducing loads on a system.

1. A method of determining a location of a mobile communication device in a mobile communication network including a plurality of base stations, comprising the steps of:
receiving a plurality of pieces of base station signal information, the base station signal information including base station identification information, the base stations transmitting the base station signal information to the mobile communication device;
determining a base station corresponding to each of the plurality of pieces of base station signal information based on the base station identification information;
generating vector information associated with the plurality of the base stations based on geographic information corresponding to the determined base station; and
generating location information of the device according to the generated vector information,
wherein the step of generating the vector information comprises the steps of:
determining a predetermined vector proceeding order associated with the plurality of the base stations according to the base station signal information; and
sequentially determining a vector with respect to the plurality of the base stations according to the determined vector proceeding order, with the base station in which the device is currently communicating with as a starting point.

2. The method of claim 1, wherein the mobile communication network is based on a synchronous network and the base station signal information comprises propagation delay time information, and, in the step of determining the predetermined vector proceeding order, the vector proceeding order is determined by the order of the small propagation delay time.

3. The method of claim 1, wherein the mobile communication network is based on an asynchronous network and the base station signal information comprises received signal strength information, and, in the step of determining the predetermined vector proceeding order, the vector proceeding order is determined by the order of the strength of the measured received signal.

4. The method of claim 1, wherein the base station signal information comprises received signal strength information, and, in the step of determining the predetermined vector proceeding order, a base station associated with the base station signal information whose measured received signal strength is less than a predetermined value is excluded from the vector proceeding order.

5. The method of claim 1, wherein the step of sequentially determining the vector with respect to the plurality of the base stations comprises the steps of:
determining a direction of the vector from a first base station that is a former to a second base station that is a latter;
computing a distance between the first base station and the second base station and determining the size of the vector by multiplying the distance by a predetermined value; and
determining the vector between the first base station and the second base station based on the direction and the size of the vector.

6. The method of claim 5, wherein the predetermined value becomes gradually reduced according to the vector proceeding order.

7. A method of determining a location of a mobile communication device in a mobile communication network including a plurality of base stations and repeaters, comprising the steps of:
receiving a plurality of pieces of base station signal information transmitted from the base station to the device;
determining one of a base station and a repeater corresponding to each of the base station signal information based on propagation delay time information;
generating vector information associated with the plurality of the base stations and repeaters based on geographic information corresponding to one of the determined base station and the repeater; and
generating location information of the device according to the generated vector information,
wherein the step of generating the vector information comprises the steps of:
determining a predetermined vector proceeding order associated with the plurality of the base stations and repeaters according to the base station signal information; and
sequentially determining a vector with respect to the plurality of the base stations and repeaters according to the determined vector proceeding order with one of the base station and repeater in which the device is currently communicating with as a starting point.

8. The method of claim 7, wherein the mobile communication network is based on a synchronous network, the base station signal information comprises a propagation delay time, and, in the step of determining the predetermined vector proceeding order, the vector proceeding order is determined to be in the order of the smallest to the largest propagation delay time.

9. The method of claim 8, wherein the step of determining the one of the base station and repeater corresponding to each of the base station signal information comprises the steps of:
determining a first propagation delay time that is the smallest of the propagation delay times;
determining a time difference between a second propagation delay time and the first propagation delay time; and
determining the base station signal information associated with the second propagation delay time to be base station signal information going by way of the repeater in the case the time difference is not less than a predetermined value.

10. The method of claim 9, wherein the step of determining the base station signal information associated with the second propagation delay time to be the base station signal information going by way of the repeater comprises the step of determining the repeater located closest to the base station associated with the base station signal information received first of the plurality of the base station signal to be the repeater of which the base station signal information goes by way in the case the base station associated with the second propagation delay time is connected to the plurality of the repeaters.

11. The method of claim 7, wherein the mobile communication network is based on an asynchronous network and the base station signal information comprises a round trip time.

12. The method of claim 11, wherein the step of determining the one of the base station and the repeater corresponding to the each of the base station signal information comprises the step of determining the base station signal information associated with the round trip delay time to be the base station signal information going by way of the repeater in the case the round trip delay time is not less than a predetermined value.

13. The method of claim 12, wherein the step of determining the base station signal information associated with the round trip delay time to be the base station signal information going by way of the repeater comprises the step of determining the repeater connected to the base station located closest to the base station whose received signal strength is greatest, excluding the base station with which the device is currently communicating with, to be the repeater of which the base station signal information going by way of the repeater associated with the round trip delay time is connected to a plurality of the repeaters.

14. The method according to claim 1, further comprising the steps of:
dividing an area covered by the mobile communication network into a plurality of grids, determining second base station signal information with respect to the divided grid in association with second location information, storing and maintaining the second base station signal information in a second database, the second location information determined with respect to the divided grid by a predetermined second device location determination method;
searching the second location information corresponding to the base station signal information from the second database by comparing the base station signal information and the second base station signal information; and
generating final location information based on the second location information and the location information.

15. The method of claim 14, wherein the step of generating the final location information comprises one of the steps of averaging the location information and the second location information, and multiplying each of them by a weight.

16. The method of claim 14, wherein the second device location determination method is performed by using a GPS receiving apparatus.

17. The method of claim 14, further comprising the steps of:
determining third location information by using a second device including the GPS receiving apparatus;
receiving third base station signal information with respect to the third location information by using the second device; and
updating the second base station information stored in the second database based on the third base station signal information.

18. The method of claim 17, wherein the updated second base station information (a′) is determined according to a′=w*(1−w)*b (a: second base station information, b: third base station information, and 0<w<1).

19. A location determination system for determining a location of a mobile communication device in a mobile communication network including a plurality of base stations and repeaters, comprising:
a data collection unit receiving a plurality of pieces of base station information transmitted from the base station to the device;
a signal analysis unit determining one of the base station and the repeater corresponding to each of the base station signal information based on the base station signal information;
a vector generating unit generating vector information associated with the plurality of the base stations and the repeaters based on geographic information corresponding to the one of the determined base station and the repeater; and
a location determination unit determining location information of the device according to the generated vector information,
wherein the vector generating unit determines a predetermined vector proceeding order associated with the plurality of the base stations according to the base station signal information and sequentially determining the vector with respect to the plurality of the base stations according to the determined vector proceeding order with one of the base station and the repeater with which the device is now communicating as a starting point.

20. The system of claim 19, further comprising:
a second database storing second base station signal information with respect to grids in association with second location information, an area covered by the mobile communication network being divided into the grids, the second location information being determined by a predetermined second device location determination method; and
a second location determination unit searching the second location information corresponding to the base station signal information from the second database by comparing the base station signal information and the second base station signal information and generating final location information based on the location information and the location information.

21. The system of claim 20, further comprising:
a third location determination unit determining third location information by using a second device including a GPS receiving apparatus;
a second data collection unit receiving third base station signal information with respect to the third location information by using the second device; and
a base station information update unit updating the second base station information stored in the second database based on the third base station signal information.

22. The system of claim 19, wherein the location determination system is installed in the mobile communication device.

23. A computer readable recording medium in which a program for executing the method according to claim 1 is recorded.
